(19) United States
(12) Patent Application Publication
(10) Pub. No.: US 2015/0039995 A1
(43) Pub. Date: Feb. 5, 2015

(54) METHOD FOR DISPLAYING CONTEXT-RELEVANT SUPPLEMENTARY INFORMATION

(71) Applicant: solute GmbH, Karlsruhe (DE)

(72) Inventors: Lorenz Petersen, Roeschwoog (FR); Kai Bleek, Weingarten (DE); Roland Sommer, Karlsruhe (DE); Benjamin Wesch, Muenchen (DE)

(21) Appl. No.: 14/376,885

(22) PCT Filed: Feb. 14, 2013
(86) PCT No.: PCT/DE2013/100058

§ 371 Date: Aug. 6, 2014

(30) Foreign Application Priority Data
Feb. 17, 2012 (DE) 10 2012 101 316.0

(51) Int. Cl. G06F 17/30; H04L 29/08

(52) U.S. Cl. CPC G06F 17/30905; G06F 17/30887; H04L 67/10; H04L 67/02
USPC 715/234

(57) ABSTRACT

Method for displaying context-relevant supplementary information in conjunction with an internet page. The prior art discloses methods for displaying context-relevant supplementary information within the framework of browser-assisted methods. Starting from this prior art, the invention is based on the object of providing a browser-independent, i.e. operating-system-protected, method in order thereby to allow the display of independent consumer information. To this end, a piece of advisory software is installed at the operating system level, the advisory software implementing a proxy server on the user computer, which evaluates related internet contents, or the related internet contents are evaluated at network level, for example by evaluating the related network packets in respect of the URL, and this is taken as a basis for deciding whether it makes sense and is possible to display supplementary information in this regard. In both cases, the consumer information may then be drawn from a, preferably from a central, database and the latter then displayed independently of browser in conjunction with the internet contents.

The present invention relates to a method for display of context-relevant supplemental information to complement Internet contents that have been called up. Such methods have been known in the state of the art for some time, whereby additional information, particularly sales information, can be displayed on a website, particularly in the case of product-related Internet contents. This is generally done in that corresponding supplemental programs are compiled in the corresponding browser, which, in the case of predetermined events, such as a mouse click on a product, procure the corresponding information either from a database stored by the user, in each instance, or directly from the Internet, and display it.

In the simplest case, this is ordering information or a connection with an Internet shop, in order to be able to order the product in which the user, in each instance, has shown an interest, directly.

The problem in the case of such browser-supported supplemental information consists in that the corresponding supplemental information is generally not offered by an independent vendor, but rather either with the approval or of directly by the provider, in each instance, of the Internet page that has just been called up.

A possible alternative could be browser-supported supplemental programs that are installed by the user himself/herself, in each instance, in order to be able to have information independent of the vendor, in each instance, displayed to him/her in this way. In this connection, however, the problem exists that in general, the providers protect the information displayed by them from access by such a supplemental program, in order not to be exposed to unwanted comparisons with third-party vendors in this regard.

The methods known in this connection are comprehensively described in the German patent DE 100 33 134 B4, for example.

The problem therefore exists that on the one hand, there is obviously a need for such supplemental information relating to Internet contents, and on the other hand, the suppliers of such Internet contents tend to be more interested in exclusively offering their own supplemental information in this connection, i.e. to exclude supplemental offers from third parties in this connection.

The invention is based on the task of creating a method for display of context-relevant supplemental information in which the supplemental information offered in this regard is independent of the operator of the Internet page called up, and of the Internet browser used, in each instance.

This task is accomplished by means of a method according to claim 1 or 2. Advantageous embodiments of this method can be derived from claims 3 to 7.

Because, in contrast to the state of the art, the supplemental information is delivered by means of an advisory software compiled on the basis of the operating system, in each instance, in other words in browser-independent manner, it is possible to display the data procured from the Internet in conjunction with supplemental information that is made available by an independent service. This is possible because the Internet query by the user, in each instance, in no way differs from a conventional Internet query, and therefore display of the independent information cannot be suppressed, and furthermore, the query for the data of the home page, in each instance, required for selection of the context-relevant supplemental information, are not blocked or, to state it better, cannot be blocked by means of corresponding supplemental programs. In a technical regard, this is made possible in that a local proxy server is implemented on the part of the user, in decentralized manner, by means of the advisory software, and subsequently, all or at least selected Internet pages are displayed by way of this proxy server, if necessary in conjunction with stored additional context-relevant supplemental information or such information currently procured from the Internet, in browser-independent manner, in each instance.

For the user's security, the proxy server can be shut off on the user side, so that the evaluation of the Internet contents procured on the user side and the decision as to whether or not he/she wants to turn the advisory software on always lies exclusively with the user.

In an alternative embodiment, the advisory software can also undertake the evaluation of the procured Internet contents on a network level, for example by means of evaluation of the procured network packets with regard to the URL, and can decide, as a function of this, whether the display of supplemental information is practical and possible in this regard. Here, too, the supplemental information is displayed in browser-independent manner.

In the solution using a proxy server, the advisory software is operated in conjunction with an auto-configuration file. The evaluation of the requests and/or of the procured Internet contents then takes place automatically, by means of the rules established in the auto-configuration file, in conjunction with the queried URLs with which the request was passed by way of the proxy server. This auto-configuration file can therefore be regularly updated. If the data are passed by way of the proxy server, they can be evaluated by means of the advisory software and, if applicable, displayed in conjunction with supplemental information.

If the requests are not rerouted by way of a proxy server but rather are evaluated on a network level in accordance with claim 2, the request is checked with regard to the currently queried URL, for example, within the scope of a separate server query, and in the event that the queried address could relate to data that require display of the context-relevant supplemental information or make it practical, the “respond” is supplemented with supplemental information also procured from this server, if necessary.

In conjunction with this solution, it appears to be even more urgent to offer a transparent system to the user. The advisory software therefore displays whether or not is active and can be turned off and on by the user, as needed.

In this connection, it has proven itself if the advisory software is installed in conjunction with a database that can be constantly supplemented, for filing of the relevant Internet contents, for example in the form of the URL of these Internet contents, in each instance, and then it is decided, as a function of a query to the database, in each instance, whether or not the current Internet request of the user, in each instance, relates to an Internet page whose content could relate to data that could require display of the context-relevant supplemental information or make it practical. In this case, the supplemental information can be displayed directly in conjunction with the queried Internet page.

Use of the method according to the invention is significantly facilitated in that the context-relevant supplemental information is automatically procured by the advisory software when an Internet page relevant for this is called up, and subsequently displayed in conjunction with the Internet page called up by the user, but independent of the browser used.

In a further embodiment of the invention, the context-relevant supplemental information is stored in a local database and automatically updated, for example when an Internet connection exists, by means of data reconciliation, so that the supplemental information can be available to the user even offline, in the sense of a caching method, or the corresponding data can be displayed more quickly than if they first had to be procured from the net. Otherwise, the queried Internet page is evaluated using the proxy server, and then the supplemental information to be displayed is procured from a central database, using these selected data, and displayed.

In an alternative embodiment, the local database can also be stored centrally, but in user-related and protected manner, in what is called the Cloud.

Furthermore, the invention will be explained in greater detail below, using a method diagram shown in the drawing.

This shows:

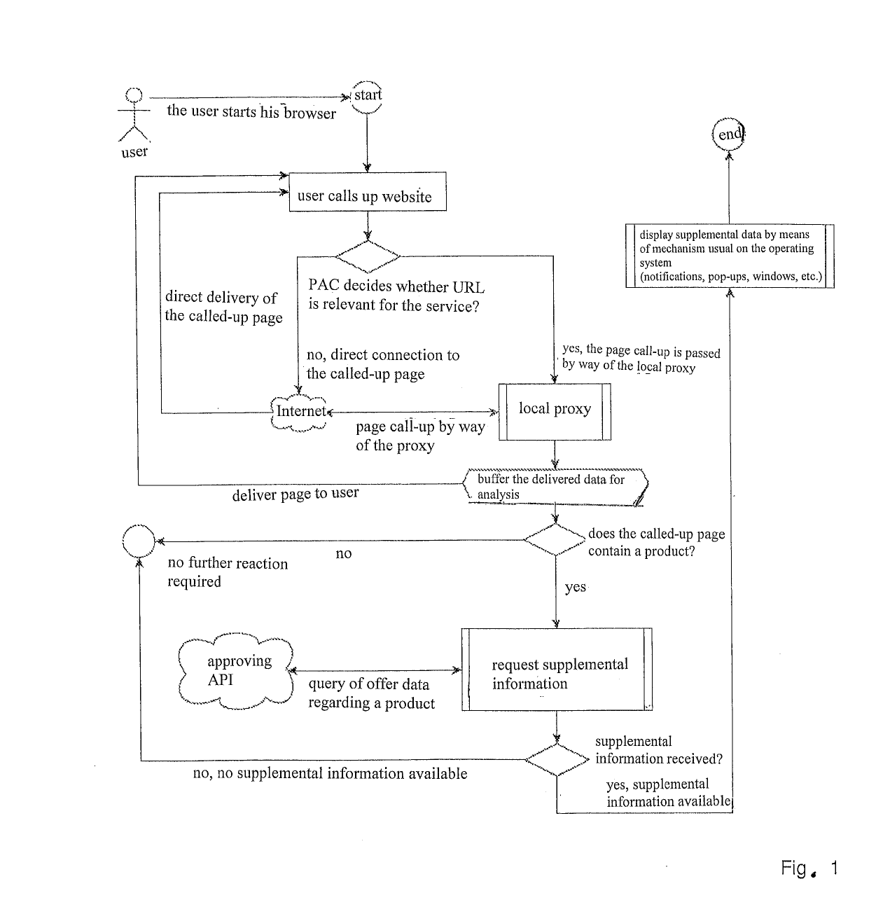

FIG. 1 A method diagram for procurement of the context-relevant supplemental information.

Proceeding from a situation in which the advisory software for procurement of the context-relevant supplemental information is already installed, on an operating system basis, on the computer of the user, which can be connected with the Internet, the method diagram describes a conventional Internet request by a user. For this purpose, the user calls up a specific Internet page by means of starting his/her browser and selecting an Internet page that is of interest to him/her.

With the installation of the advisory software, what is called a proxy server is installed on the computer of the user. As soon as the user now starts his/her browser, any Internet request is evaluated by means of reconciliation with an auto-configuration file that is automatically updated at regular intervals. This file essentially contains a compilation of the Internet addresses relevant for the display of context-relevant supplemental information, in other words the URLs that are relevant in this regard. A query of the file, in each instance, is simultaneously connected with the call-up of a website by the user, by way of the browser, in each instance; this query relates to whether the URL in question belongs to the relevant Internet pages stored in the database.

As a function of this query, it is then decided whether the called-up Internet page will be displayed directly in the conventional browser or whether the request will additionally be passed by way of the proxy server for the purpose of evaluation by means of the advisory software. It is decided on the basis of a set of rules compiled in the auto-configuration file whether rerouting by way of the proxy server takes place. In the event that the page is displayed by the browser directly, display of further supplemental information by way of the system according to the invention is not possible.

However, if rerouting by way of the proxy server takes place, an evaluation of the called-up page takes place, for example whether the requested Internet page contains the offer of a product. In this connection, other queries, for example for persons of interest or the like, can also be carried out within the scope of the invention.

In an alternative embodiment, all the requests can also fundamentally be passed by way of the proxy server, then an evaluation can be carried out as to whether supplemental information is available for the request, and then the requested Internet content can be displayed in conjunction with the supplemental information, whereby the display of the supplemental information takes place not in the browser but separate from it, for example in a pop-up.

In yet another alternative embodiment, it is also possible to do without the proxy server entirely. Instead, the evaluation of the procured network packets is carried out on the network level, for example by means of extraction of the URLs, in each instance, in order to recognize whether supplemental information can be offered with regard to the Internet content in question, which information is then, in turn, procured in browser-independent manner and displayed.

In the event that the evaluation by means of the proxy server yields the result that the contents of the called-up page relate to information with regard to which supplemental information is available, if applicable, the supplemental information is automatically queried by means of the advisory software. In this connection, the query can be directed to a locally stored database or also to a centrally stored database, in other words to a database stored in a Cloud or at a service provider, or the supplemental information is called up from an Internet page compiled in fixed manner in the advisory software, in other words from an independent comparison portal, for example.

As soon as the supplemental information procured in this way is delivered in response to the query, it is shown either in an additional window, as a comment, or as what are called pop-ups, in connection with the Internet page, independent of the browser.

The invention therefore relates to a method for display of context-relevant supplemental information that can be procured either from a local or a decentralized database, or from an independent vendor. In a preferred application, this can be a price comparison database that supports the user in his/her purchase decision, for example with information uncoupled from the product vendor, as to whether or not the offer just being queried is comparatively advantageous.

1. Method for display of context-relevant supplemental information to complement Internet contents that have been called up, wherein the display of the context-relevant supplemental information is implemented in browser-independent manner, in that the Internet contents selected by the user by means of a request, by means of a browser-independent advisory software, are evaluated, preferably using the called-up URL, with regard to their relevance relative to the supplemental information, and then, as a function of the result of this evaluation, the called-up Internet contents are displayed, if applicable in conjunction with the supplemental information automatically procured from a database, preferably a central database, by means of the advisory software, wherein the display of this supplemental information takes place completely uncoupled from the browser, wherein the advisory software comprises a proxy server, and wherein the display of said supplemental information takes place as a function of the result of the evaluation of the requests entered by the user, by means of reconciliation of the data of the request with a locally and/or centrally stored auto-configuration file that contains a set of rules on the basis of which, preferably by means of analysis of the URLs, it is decided whether the request will be passed by way of the proxy server, wherein in the event of rerouting by way of the proxy server, the data procured within the scope of the request are further evaluated, if necessary, and the supplemental information is procured and displayed, wherein the request triggered by the user differs in no way, from the point of view of the server being called up, in each instance, from a conventional request, in other words without the evaluation of the network packets procured within the scope of the request, on the network level.

2. Method for display of context-relevant supplemental information to complement Internet contents that have been called up, wherein the display of the context-relevant supplemental information is implemented in browser-independent manner, in that the Internet contents selected by the user by means of a request, by means of a browser-independent advisory software, are evaluated, preferably using the called-up URL, with regard to their relevance relative to the supplemental information, and then, as a function of the result of this evaluation, the called-up Internet contents are displayed, if applicable in conjunction with the supplemental information automatically procured from a database, preferably a central database, by means of the advisory software, wherein the display of this supplemental information takes place completely uncoupled from the browser, wherein the advisory software evaluates the user-side requests, preferably their URLs, and/or the network packets procured within the scope of a request, on the network level, and it is decided, preferably by means of analysis of the URLs, whether the request will be passed by way of the proxy server, wherein the request triggered by the user differs in no way, from the point of view of the server being called up, in each instance, from a conventional request, in other words without the evaluation of the network packets procured within the scope of the request, on the network level.

3. Method according to claim 1, wherein the information is displayed to the user, preferably outside of the browser, as to whether the advisory software is switched to active or passive, and/or can be switched to active or passive on the user side.

4. Method according to claim 1, wherein the context-relevant supplemental information is stored in a database, preferably a centrally stored database, and is selected and displayed by means of a matching method with the data recorded with regard to the request, in each instance.

5. Method according to claim 1, wherein the context-relevant supplemental information is automatically procured by the advisory software on the basis of an Internet request, at a predeterminable Internet address, when an Internet page is called up, and displayed independent of the browser, in each instance.

6. Method according to claim 1, wherein the context-relevant supplemental information is stored in a local database compiled by the user, and automatically updated, if an Internet connection exists, by means of data reconciliation by the advisory software with a central database of the context-relevant supplemental information.

7. Method according to claim 1, wherein the local and/or the central database is stored in the Cloud, in user-related and decentralized manner.
